(19) United States
(12) Patent Application Publication
(10) Pub. No.: US 2013/0105379 A1
(43) Pub. Date: May 2, 2013

(54) Magnetic Fluid Filter

(71) Applicant: Solomon Lee, Newhall, CA (US)

(72) Inventor: Solomon Lee, Newhall, CA (US)

(21) Appl. No.: 13/398,483

(22) Filed: Feb. 16, 2012

Related U.S. Application Data
(60) Provisional application No. 61/551,736, filed on Oct. 26, 2011.

(51) Int. Cl. B01D 35/06

(52) U.S. Cl. 210/222

(57) ABSTRACT

The present invention relates to a magnetic fluid filter device and, more specifically, to a magnetic fluid filter for removing ferro-magnetic particles from a fluid in addition to filtering the fluid. The magnetic fluid filter includes an upper end cap having a centrally located aperture, a lower end cap, a filtering material, and a magnet, for removing ferro-magnetic particles from the fluid, integrally attached to a top surface of the upper end cap wherein the fluid is effectively exposed to a magnetic flux of the magnet before entering the filtering material. The magnet is annular or ring-shaped and substantially coaxially located with respect to the aperture. An additional second magnet is attached to a bottom surface of the lower end cap.

### CROSS REFERENCE TO RELATED APPLICATIONS

This application claims the benefit of the filing date of U.S. provisional patent application Ser. No. 61/551,736, filed on Oct. 26, 2011, the disclosure which is incorporated herein by reference.

### BACKGROUND OF THE INVENTION

The present invention relates to a magnetic fluid filter device and, more specifically, to a magnetic fluid filter for removing ferro-magnetic particles from a fluid in addition to filtering the fluid. The fluid may be oil, fuel, transmission fluid or hydraulic fluid, and the magnetic fluid filter may be mounted on engines, diesel engines, engines or transmissions of motor vehicles, fuel delivery systems, or hydraulic systems including but not limited to, automobiles, marine vehicles, heavy duty trucks, or heavy duty industrial machinery.

A number of fluid filtering systems have been disclosed and are being used to filter the fluid circulating in the engine, transmission, fuel, or hydraulic system. The fluid filtering system generally includes a filter 100, a filter housing 200, and inlet 300 and outlet 400 of the engine, transmission, fuel, or hydraulic system as in FIGS. 2(A) and 2(B). The filter 100 generally includes an upper end cap 110, a filtering material 130, and a lower end cap 120 as in FIGS. 1(A) and 1(B). The filtering material 130 is generally constructed such that an array of filtering material 130 is arrayed circumferentially around the centrally located filtered fluid flow space 132. When the fluid filter 100 and the filter housing 200 are detachably attached to the engine, transmission, fuel, or hydraulic system, the fluid flows into the filter housing 200 through the inlet 300 located right above the upper end cap 110. Then, the fluid flows around the upper end cap 110 and radially in a diffuse pattern from circumferential positions outside the filtering material 130, through the filtering material 130, and into the centrally located filtered fluid flow space 132. The fluid flows out of the filter housing through the aperture 112 centrally located on the upper end cap and through the outlet 400, going back to the engine, transmission, fuel, or hydraulic system.

Conventional oil, transmission, fuel, or hydraulic filters rely on a porous filtering material that captures large impurities in the fluid. However, they failed to filter many metallic or ferro-magnetic particles, such as metal shavings from worn engine, transmission, fuel, or hydraulic parts, which are smaller than the pores of the filtering material. Therefore, many of the metallic particles are not filtered by the filtering material and continue to circulate through the engine, transmission, fuel, or hydraulic system causing damages, such as filter clogging or engine wear, to the system.

The use of magnets to the fluid filter or fluid filtering device is known to have improved filtering performance because a magnet attracts and retains metallic or ferro-magnetic particles present in the fluid flowing around or inside the oil filter, thereby separating those particles from the flowing fluid. A number of magnetic filtering devices have been disclosed. For example, in U.S. Pat. No. 6,632,354, a magnetic assembly is provided to the filter body and in U.S. Pat. No. 4,629,558, a magnetic element is provided to the lower end cap of the filter.

However, these devices have limitations. The filter of U.S. Pat. No. 6,632,354 is questionable for the effectiveness of the magnetic assembly. The filter of U.S. Pat. No. 4,629,558 has a magnet mounted on the lower end cap where magnetic field does not cover the whole oil flow, and thus, the magnetic filtering performance is limited. For other conventional magnetic filters, the magnetic structure is generally either bulky, inefficient, and expensive to manufacture, or independently attachable to the fluid filter such that a user has to separately purchase the magnetic device in addition to the filter and install it to the fluid filter system. It is cumbersome for a user to buy and install an additional device. It may also cause hazardous conditions if the attached magnetic apparatus was to become dislodged during transit.

Accordingly, a need for a magnetic fluid filter, simple in structure, inexpensive to manufacture, easy to use, and more effective in filtering ferro-magnetic particles has been present for a long time considering the expansive demands in everyday life. This invention is directed to solve these problems and satisfy a long-felt need.

### SUMMARY OF THE INVENTION

The present invention presents a magnetic fluid filter which comprises an upper end cap, a filtering material, and a lower end cap wherein an annular or ring-shaped magnet is provided to the top surface of the upper end cap. Additional annular or ring-shaped magnet may be provided to the bottom surface of the lower end cap. Here, among the two end caps, the upper end cap means the cap having a centrally located aperture, and when installed, located nearer to the inlet than the other cap.

The object of this invention is to provide a magnetic fluid filter in a very simple structure, but having an improved filtration performance. Because of the simple structure, manufacturing cost can be saved. In addition to the filtering material, a magnet is provided to the upper end cap to attract foreign substance such as metallic or ferro-magnetic particles.

Another object of this invention is to provide a magnetic oil, fuel, transmission, and hydraulic fluid filter which comprises an upper end cap, a filtering material, and a lower end cap wherein ring-shaped magnets are provided to the top surface of the upper end cap and the bottom surface of the lower end cap and the magnets rest in pocket areas of the end caps. The pocket area is recessed from the surface of the end caps and larger than the magnet so that ferro-magnetic particles can accumulate in the space between the magnet and the recessed area. Since ferro-magnetic particles accumulate in a recessed pocket area, they are prevented from being swept away by internal fluid pressure and flow within the applied system.

The advantages of the present invention include that (1) the magnetic fluid filter of the present invention has improved filtering performance since in addition to a regular filtering material, a magnet attached to the top end cap filters ferro-magnetic particles in the fluid; (2) the magnetic fluid filter of the present invention has a very simple structure because an annular or ring-shaped magnet is integrally provided to the end cap of a regular oil filter and thus, it is easy to manufacture at a reduced cost; (3) the magnetic fluid filter of the present invention lengthens the life span of the filtering material because it captures ferro-magnetic particles which cause damages to the filtering material; and (4) the magnetic fluid filter is easy to change because it just modifies existing fluid filters and there is no additional installment necessary.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will be better understood with reference to the accompanying drawings, wherein:

FIGS. 1(A) and 1(B) are perspective views of conventional fluid filters showing the upper end cap;

FIGS. 2(A) and 2(B) are cross-sectional views of the fluid filter mounted to the filter housing and to the engine, transmission, or hydraulic system;

FIG. 3(A) is a perspective view of the present invention showing the upper end cap;

FIG. 3(B) is a perspective view of the present invention showing the lower end cap;

FIG. 3(C) is a cross-sectional view of the present invention;

FIG. 4 is a cross-sectional view of the present invention mounted to the filter housing and to the engine, transmission, or hydraulic system;

FIG. 5(A) is a perspective view of another embodiment of the present invention;

FIG. 5(B) is a top view of another embodiment of the present invention;

FIG. 5(C) is a cross-sectional view of the upper end cap of another embodiment of the present invention;

FIG. 6(A) is a perspective view of still another embodiment of the present invention;

FIG. 6(B) is a top view of still another embodiment of the present invention;

FIG. 7(A) is a perspective view of still another embodiment of the present invention;

FIG. 7(B) is a top view of still another embodiment of the present invention; and

FIG. 7(C) is a cross-sectional view of the upper end cap of still another embodiment of the present invention;

### DETAILED DESCRIPTION EMBODIMENTS OF THE INVENTION

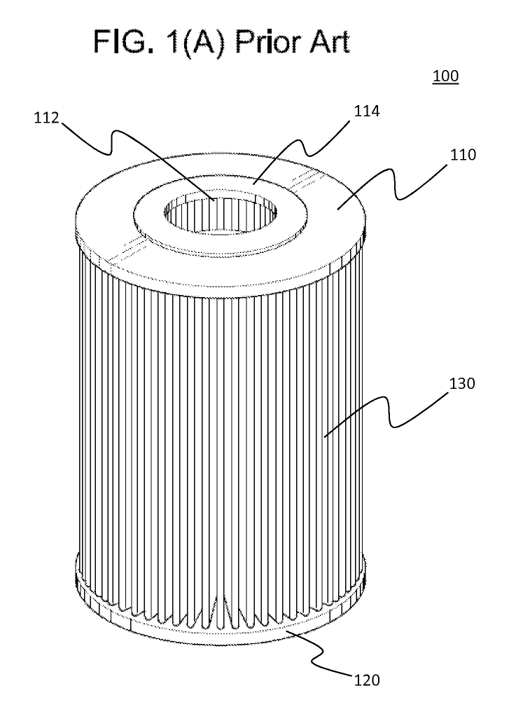

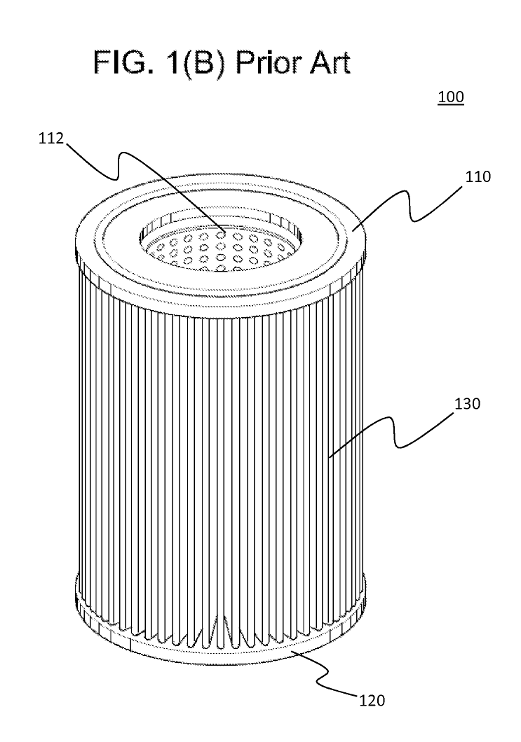

FIGS. 1(A) and 1(B) show conventional plastic and metallic fluid filters 100. Both types of filters 100 have the upper end cap 110, the lower end cap 120, and the filtering material 130. The upper end cap 110 includes a centrally located aperture 112 and an array of filtering material 130 that is arrayed circumferentially around the centrally located filtered fluid flow space 132 which is not shown. The upper end cap 110 may additionally include a seal 114.

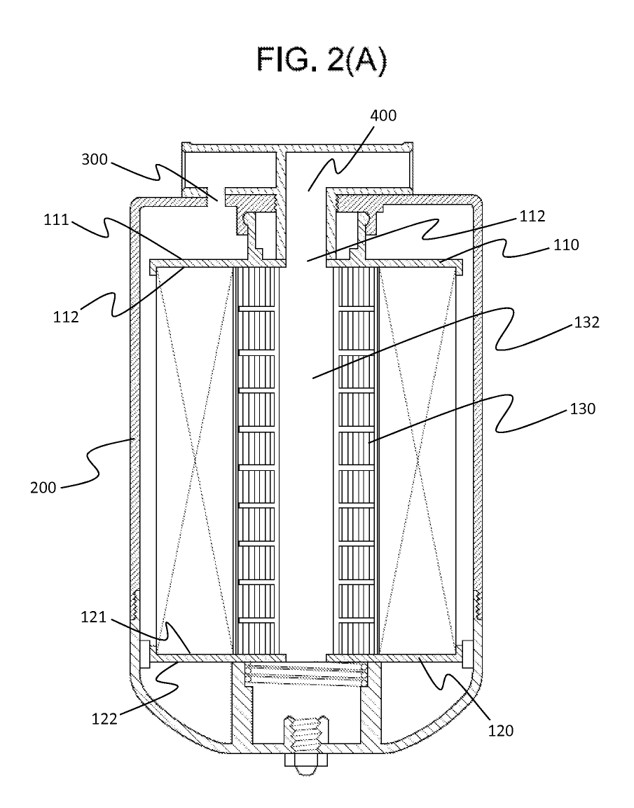

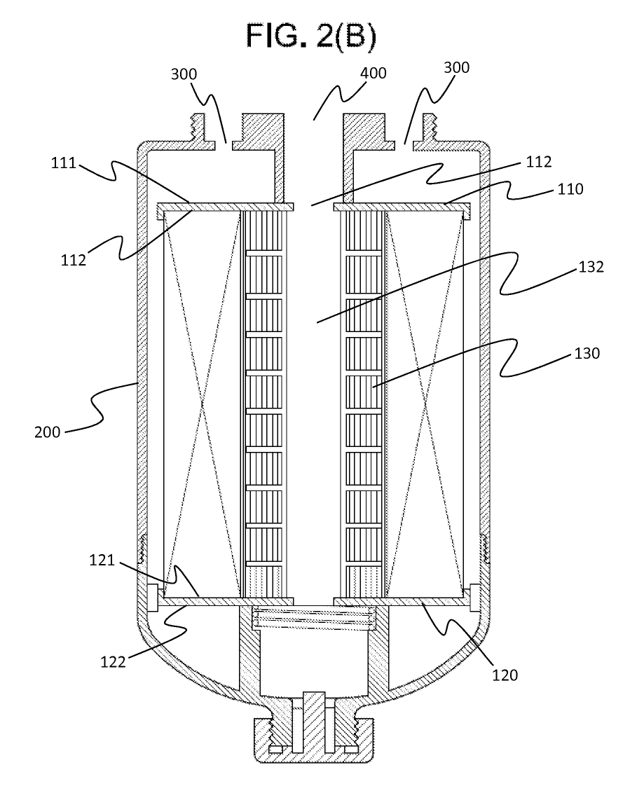

FIGS. 2(A) and 2(B) shows cross-sectional views when the fluid filter 100 mounted to the filter housing 200 and to the engine, transmission, or hydraulic system. The fluid flows into the filter housing 200 through the inlet 300 located right above the upper end cap 110. Then, the fluid flows around the upper end cap 110 and radially in a diffuse pattern from circumferential positions outside the filtering material 130, through the filtering material 130, and into the centrally located filtered fluid flow space 132. The fluid flows out of the filter housing through the aperture 112 centrally located on the upper end cap and through the outlet 400, going back to the engine, transmission, or hydraulic system. Some fluid may flow around or below the lower end cap 120 before entering the filtering material 130.

As the fluid enters the filter housing 200 through the inlet 300, it hits the top surface 111 of the upper end cap 110 and flows around the upper end cap to the filtering material 130. Therefore, if a magnet is provided to the top surface 111 of the upper end cap 110, the fluid is effectively exposed to a magnetic flux of the magnet. If the top surface 111 of the upper end cap 110 has a recess or a pocket 160 to receive the magnet 140, the fluid has to make a slightly upward flow after hitting the pocket area 160. Because of this upward flow, metallic or ferro-magnetic particles can be attracted to the magnet 140 and cumulated in the pocket area 160. In addition, the pocket 160 prevents the cumulated ferro-magnetic particles from being swept away by the high pressure of the applied system and fluid flow.

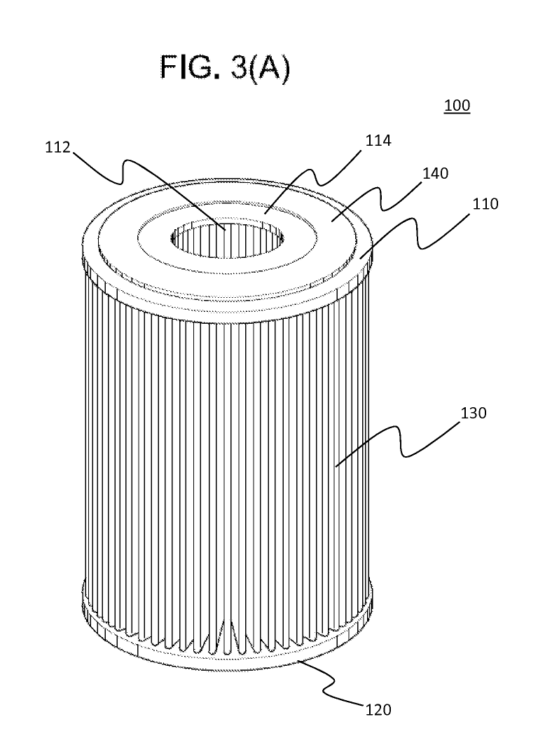

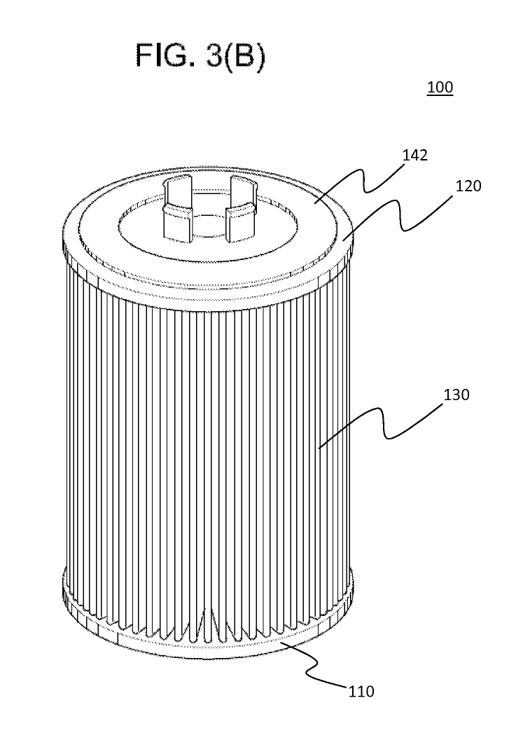

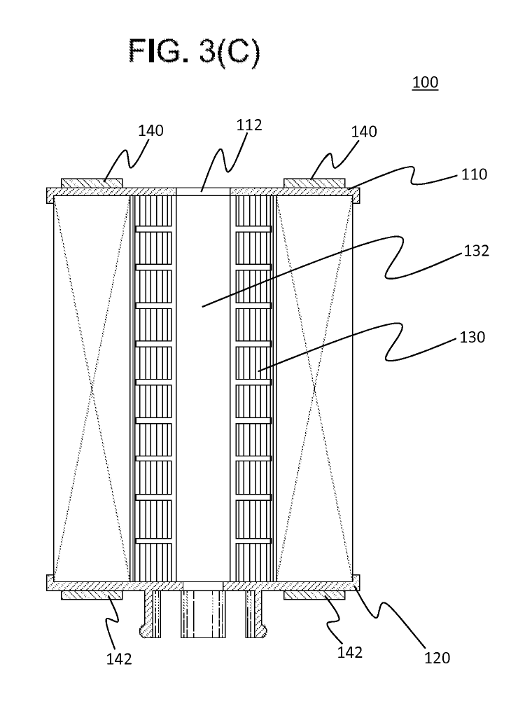

FIGS. 3(A), 3(B), and 3(C) show perspective views and cross-sectional view of the present invention. The magnetic fluid filter 100 of the present invention particularly for removing ferro-magnetic particles from the fluid includes an upper end cap 110 having a centrally located aperture 112; a lower end cap 120 located opposite to the upper end cap 110 wherein the upper end cap 110 and the lower end cap 120 are substantially flat as shown in the figures; a filtering material 130, for filtering the fluid, integrally attached to a bottom surface 112 of the upper end cap 110 and a top surface 121 of the lower end cap 120 wherein all of the fluid passing through the filtering material 130 exits through the aperture 112 of the upper end cap; and a magnet 140, for removing ferro-magnetic particles from the fluid, integrally attached to a top surface 111 of the upper end cap 110 wherein the fluid is effectively exposed to a magnetic flux of the magnet 140 before entering the filtering material. Here, the fluid may be oil, fuel, transmission fluid or hydraulic fluid, and the magnetic fluid filter may be mounted on engines, diesel engines, engines or transmissions of motor vehicles, fuel delivery systems, or hydraulic systems including but not limited to, automobiles, marine vehicles, heavy duty trucks, or heavy duty industrial machinery.

Although various uses of the invention have been described in some detail, it is to be realized that the invention is not to be limited thereto but can include various other uses falling within the spirit and scope of the invention.

The magnet 140 is annular or ring-shaped and substantially coaxially located with respect to the aperture 112. The magnet 140 is attached to the flat top surface 111 of the upper end cap 110 by an adhesive. Alternatively, the flat top surface 111 may have a recess to fittingly receive the magnet 140 therein.

An additional second magnet 142 may be attached to a bottom surface 122 of the lower end cap 120. Although not as effective as the magnet 140, some fluid flows to the bottom of the filter 100 or the filter housing 200 near the second magnet 142 and the second magnet 142 can additionally attract and collect ferro-magnetic particles. The second magnet 142 may be attached to the lower end cap 120 identically or similarly to the magnet 140. Accordingly, the annular second magnet 142 may be attached to the flat bottom surface 122 of the lower end cap 120 by an adhesive or alternatively, it may be fittingly received in a recess on the bottom surface 122 of the lower end cap 120.

The surface of the magnet 140 and the second magnet 142 may be rough, having an uneven, irregular or bumpy surface. Rough surface of the magnets 140, 142 helps keeping ferro-magnetic particles on their surface.

FIG. 4 is a cross-sectional view of the present invention, having both of the magnets 140, 142, mounted to the filter housing and to the engine, transmission, or hydraulic system.

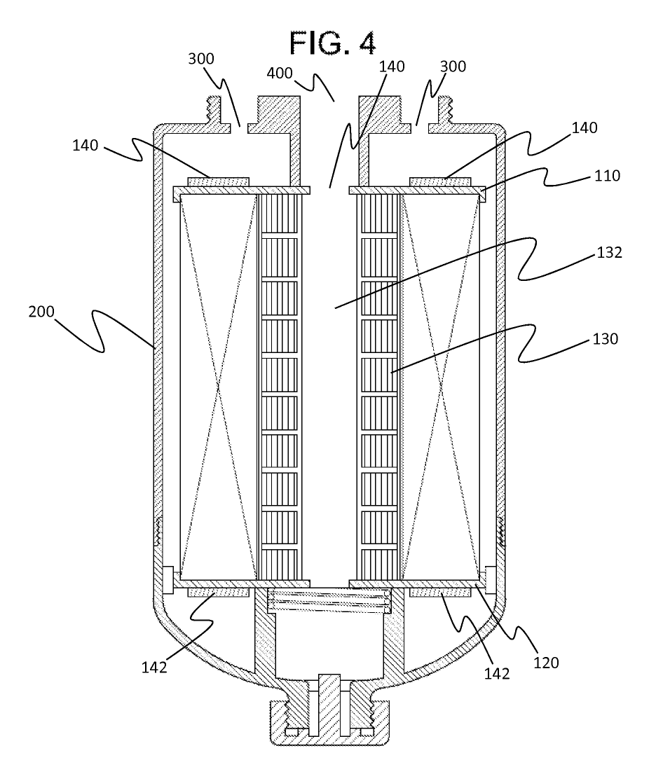

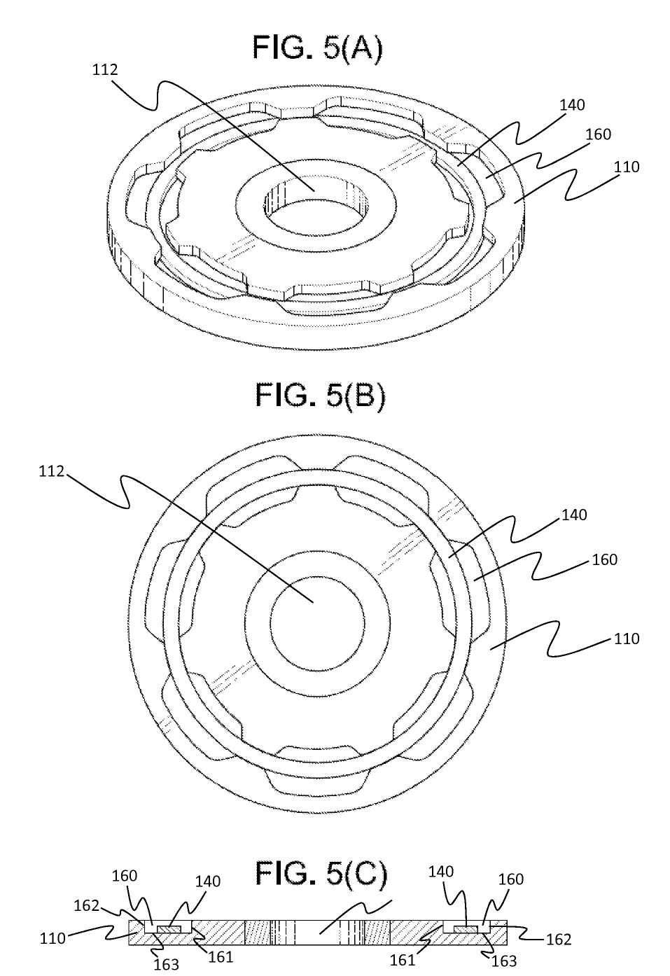

FIGS. 5(A), 5(B), and 5(C) show another embodiment of the present invention. Here, the upper end cap 110 includes a pocket 160 on the top surface 111 of the upper end cap 110 to receive the magnet therein in that the pocket 160 is a recess recessed from the top surface 111 of the upper end cap 110, having an inner wall 161, an outer wall 162 and a pocket bottom 163, and the magnet 140 is attached to the pocket bottom 163. The magnet 140 is annular or ring-shaped and substantially coaxially located with respect to the aperture 112.

There may be a gap between the outer wall 162 and the magnet 140 and the height of the magnet 140 may be smaller than depth of the pocket 160. By this structure, the fluid flows to hit the pocket 160, make a slight upward movement, and follow the surface 111 of the upper end cap 110, going around it 110 to the filtering material 130. Because of the slight upward movement, Ferro-magnetic particles can rest onto the magnet 140 and accumulate on the surface of the magnet 140 or the gap between the outer wall 162 and the magnet 140.

The pocket 160 may be annular or ring-shaped and substantially coaxially located with respect to the aperture. Alternatively, as described in FIG. 5(B), the annular pocket 160 may have additional pattern of changing width. Although a couple of pocket designs 160 have been described in some detail, it is to be realized that the invention is not to be limited thereto but can include various other pocket designs 160 falling within the spirit and scope of the invention.

The surface of the magnet 140 may be rough as described above and the outer wall 162 and the pocket bottom 163 may be rough as well. The inner wall 161 may be also rough. This rough structure helps prevent ferro-magnetic particles from being swept away by the fluid flow.

An additional second magnet 142 may be attached to a bottom surface 122 of the lower end cap 120 and it 142 may be attached to the pocket bottom of the lower end cap 120 identically or similarly to the magnet 140.

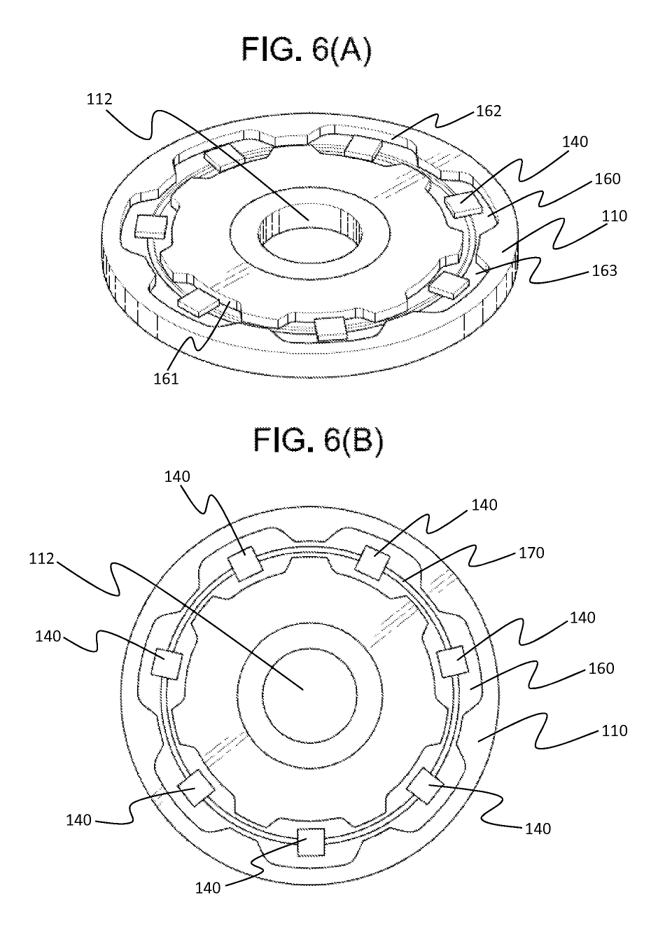

FIGS. 6(A) and 6(B) shows still another embodiment of the present invention. Here, a plurality of magnets 140 are integrally attached to a top surface 111 of the upper end cap 110 so that the fluid is effectively exposed to a magnetic flux of the magnets 140 before entering the filtering material 130. The magnets 140 may be configured in a circular pattern with respect to the aperture 112 and the pocket 160 to receive the magnets 140 may be annular or ring-shaped. Alternatively, the pocket 160 may be configured as in FIG. 6(A). A plurality of pockets 160 are on the top surface 111 of the upper end cap 110 to receive the magnets 140, being configured to form a circular pattern of one large pocket area 160 with respect to the aperture, wherein the number of pockets 160 equals the number of magnets 140. Each pocket 160 receives one magnet 140. Each pocket 160 includes walls 161, 162 and a bottom 163 and each magnet 140 is attached to the bottom 163 of each pocket 160 apart from the wall 162. The annular pocket area 160 may additionally comprise a groove 170 on its bottom 163. Although a couple of pocket designs 160 have been described in some detail, it is to be realized that the invention is not to be limited thereto but can include various other pocket designs 160 falling within the spirit and scope of the invention.

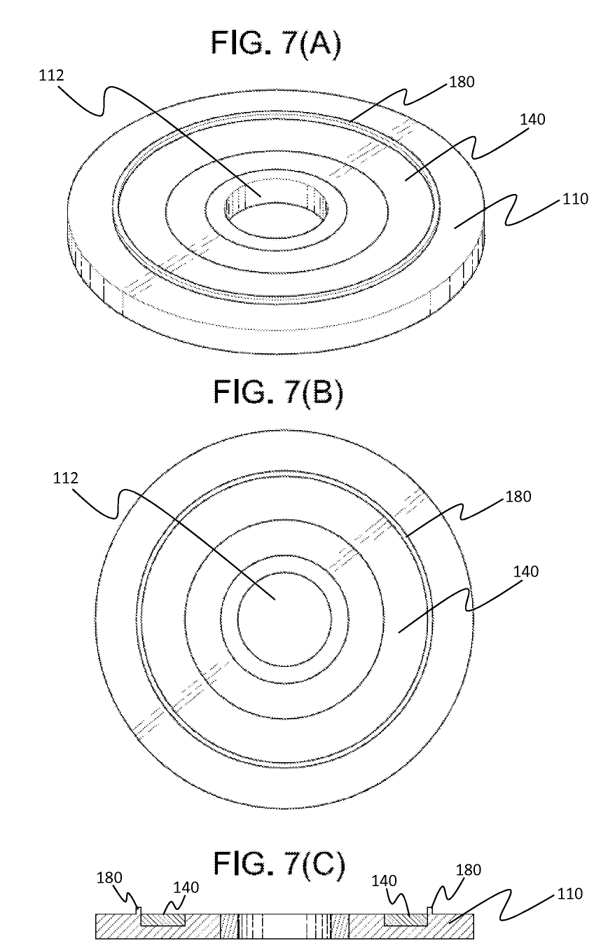

FIGS. 7(A), 7(B), and 7(C) show still another embodiment of the present invention. Here, the top surface 111 of the upper end cap 110 has a recess to fittingly receive the magnet 140. The top surface of the magnet may be coplanar with the top surface 111 of the upper end cap 110. Alternatively, the height of the recess may be greater than the height of the magnet 140 to allow accumulation of ferro-magnetic particles in the recess. The upper end cap 110 may have an annular bump 180 abutting the outer boundary of the magnet 140. The annular bump 180 helps prevent the ferro-magnetic particles from being swept away by the fluid flow.

In another embodiment of the present invention, the upper end cap 110 itself is made magnetic in its entirety. The surface of the upper end cap 110 may be rough. The lower end cap 120 may be magnetic as well for further removing of ferro-magnetic particles from the fluid.

Still in another embodiment of the present invention, the filtering material 130 may be surrounded by a mesh shaped magnet to attract ferro-magnetic particles.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A magnetic fluid filter particularly for removing ferro-magnetic particles from a fluid, comprising:
an upper end cap having a centrally located aperture;
a lower end cap located opposite to the upper end cap wherein the upper end cap and the lower end cap are substantially flat;
a filtering material, for filtering the fluid, integrally attached to a bottom surface of the upper end cap and a top surface of the lower end cap wherein all of the fluid passing through the filtering material exits through the aperture of the upper end cap; and
a magnet, for removing ferro-magnetic particles from the fluid; integrally attached to a top surface of the upper end cap wherein the fluid is effectively exposed to a magnetic flux of the magnet before entering the filtering material.

2. The magnetic fluid filter of claim 1, wherein the magnet is annular and substantially coaxially located with respect to the aperture.

3. The magnetic fluid filter of claim 1, wherein the upper end cap comprises a pocket on the top surface of the upper end cap to receive the magnet therein wherein the pocket is a recess from the top surface of the upper end cap, comprising an inner wall, an outer wall and a pocket bottom, and the magnet is attached to the pocket bottom.

4. The magnetic fluid filter of claim 3, wherein there is a gap between the outer wall and the magnet.

5. The magnetic fluid filter of claim 3, wherein the pocket is annular and substantially coaxially located with respect to the aperture.

6. The magnetic fluid filter of claim 3, wherein a surface of the magnet is rough.

7. The magnetic fluid filter of claim 3, wherein the outer wall and the pocket bottom are rough.

8. The magnetic fluid filter of claim 1, wherein the magnet is attached to the upper end cap by an adhesive and the second magnet is attached to an adhesive.

9. The magnetic fluid filter of claim 1, further comprising a second magnet, for further removing of ferro-magnetic particles from the fluid, integrally attached to a bottom surface of the lower end cap.

10. The magnetic fluid filter of claim 9, wherein the second magnet is annular and substantially coaxially located with respect to the lower end cap.

11. The magnetic fluid filter of claim 9, wherein the lower end cap comprises a pocket on the bottom surface of the lower end cap to receive the second magnet therein,
wherein the pocket is a recess from the bottom surface of the lower end cap, comprising an inner wall, an outer wall and a pocket bottom,
wherein the second magnet is attached to the pocket bottom, and
wherein the pocket is annular and substantially coaxially located with respect to the lower end cap.

12. The magnetic fluid filter of claim 11, wherein a surface of the magnet is rough and the outer wall and the pocket bottom are rough.

13. A magnetic fluid filter particularly for removing ferro-magnetic particles from a fluid, comprising:
an upper end cap having a centrally located aperture;
a lower end cap located opposite to the upper end cap wherein the upper end cap and the lower end cap are substantially flat;
a filtering material, for filtering the fluid, integrally attached to a bottom surface of the upper end cap and a top surface of the lower end cap wherein all of the fluid passing through the filtering material exits through the aperture of the upper end cap; and
a plurality of magnets, for removing ferro-magnetic particles from the fluid, integrally attached to a top surface of the upper end cap wherein the fluid is effectively exposed to a magnetic flux of the magnets before entering the filtering material.

14. The magnetic fluid filter of claim 13, wherein the upper end cap comprises a plurality of pockets on the top surface of the upper end cap to receive the magnets wherein the number of pockets equals the number of magnets and each pocket receives one magnet.

15. The magnetic fluid filter of claim 14, wherein the pockets are recesses from the top surface of the upper end cap, being configured to form a circular pattern with respect to the aperture.

16. The magnetic fluid filter of claim 14, wherein each pocket comprises a wall and a bottom and each magnet is attached to the bottom of each pocket apart from the wall.

17. The magnetic fluid filter of claim 14, wherein the plurality of pockets are connected to form an annular pocket area surrounding the aperture.

18. The magnetic fluid filter of claim 17, wherein the annular pocket area comprises a groove on its bottom.

19. A magnetic fluid filter particularly for removing ferro-magnetic particles from a fluid, comprising:
a magnetic upper end cap, for removing ferro-magnetic particles from the fluid, having a centrally located aperture;
a lower end cap located opposite to the upper end cap wherein the upper end cap and the lower end cap are substantially flat; and
a filtering material, for filtering the fluid, integrally attached to a bottom surface of the upper end cap and a top surface of the lower end cap wherein all of the fluid passing through the filtering material exits through the aperture of the upper end cap;
wherein the fluid is effectively exposed to a magnetic flux of the magnet before entering the filtering material and after exiting the filtering material.

20. The magnetic fluid filter of claim 19, wherein the lower end cap is magnetic for further removing of ferro-magnetic particles from the fluid.
